(19) United States
(12) Patent Application Publication
(10) Pub. No.: US 2012/0172403 A1
(43) Pub. Date: Jul. 5, 2012

(54) LOW TEMPERATURE STABLE SOLUTION

(76) Inventors: Thomas Koehler, Kreuzlingen TG (CH); Richard Levy, Valbonne (FR); Roger G. Hamel, Newtown, PA (US)

(21) Appl. No.: 13/326,833

(22) Filed: Dec. 15, 2011

(30) Foreign Application Priority Data
Dec. 29, 2010 (EP) 10290680.7

(51) Int. Cl. A01N 43/80; A01P 1/00

(52) U.S. Cl. 514/372

(57) ABSTRACT

This invention relates to liquid concentrates of 4,5-dichloro-2-(n-octyl-4-isothiazolin-3-one) (“DCOIT”) which are stable to crystallization or freezing at sub-freezing temperatures.

This invention relates to liquid concentrates of 4,5-dichloro-2-(n-octyl-4-isothiazolin-3-one) (“DCOIT”) which are stable to crystallization or freezing at sub-freezing temperatures.

It is well known to add biocides to thermoplastic resin compositions (i.e. plastics), caulks, sealants, and other articles in order to protect such articles against microbial degradation. For processing reasons, it is known to provide biocides as concentrates, such as liquid concentrates. Although a number of biocides have been suggested, isothiazolones, particularly DCOIT, have shown promise in such applications, especially those involving outdoor weathering of the article. However, at room temperature, many isothiazolones, including DCOIT, are in solid form and, therefore, are difficult to handle. These isothiazolones are more easily handled if dissolved in a liquid carrier, particularly a plasticizer which serves its normal plasticizing function in the end-use composition. However, even though stable at room temperature (i.e., 20-25° C.) plasticizer solutions of isothiazolones, particularly DCOIT, are known to freeze when the temperature of the solution becomes cold, as might be encountered during shipping and storage in winter climates. This is highly undesirable as a manufacturer who might receive a frozen concentrate would not only have to thaw the concentrate, but also take steps to ensure that the isothiazolone is fully re-dissolved and that the concentrate is homogeneous.

European Patent 0 910 953 discusses this freezing problem and discloses that for solution concentrates comprising between 4 and 25 weight percent of an isothiazolone compound, between 25 and 88 weight percent of one or more plasticizers in which the isothiazolone compound is soluble, and between 8 and 50 weight percent of benzyl alcohol will be stabile against crystallization and/or freezing under sub-freezing conditions. Preferably the concentrate contains at least 10 weight percent DCOIT and at least 15 weight percent benzyl alcohol and, under certain circumstances, preferably at least 15 weight percent DCOIT and at least 40 weight percent benzyl alcohol. DCOIT is the preferred compound because it exhibits improved stability (i.e., weatherability) relative to other isothiazolone compounds, particularly in outdoor conditions. U.S. Pat. No. 5,554,635 discloses concentrates of isothiazolones and plasticizers which are stabilized against crystallization or freezing at sub-zero temperatures by the addition of at least 4 weight percent of the co-biocide triclosan (2,4,4′-trichloro-2′-hydroxydiphenyl ether).

We have discovered that in combination with a certain limited class of plasticizers, isothiazolones, preferably DCOIT, do not require the presence of the cosolvent, benzyl alcohol or triclosan for stability. Our invention, therefore is a liquid concentrate, comprising a homogeneous solution of 4 to 40 weight percent isothiazolone and 60 to 96 weight percent benzoate ester plasticizer (“benzoate” or “benzoates”), wherein the concentrate is substantially free of cosolvent

For purposes of this invention, cosolvent means an organic solvent capable of dissolving and/or is soluble in the isothiazolone and the benzoate ester plasticizer including, but not limited to, benzyl alcohol and monoalkylphenols. The term “substantially free” means less than 4 weight percent, preferably less than 3 weight percent, preferably less than 2 weight percent, preferably less than 1 weight percent, and preferably 0 weight percent. The term “stable to crystallization at freezing or freezing at sub-freezing temperatures” means that at temperatures of 0° C. or less the composition remains clear or if the composition becomes turbid at temperatures of 0° C. or less it becomes clear when heated to room temperature.

Isothiazolones useful in this invention include, but are not limited to, 2-methyl-4-isothiazolin-3-one, 4-methyl-1,2-benzisothiazolin-3-one, 4-butyl-1,2-benzisothiazolin-3-one, n-octyl-4-isothiazolin-3-one, and DCOIT and mixtures thereof. Preferred isothiazolones are n-octyl-4-isothiazolin-3-one and DCOIT, more preferred is DCOIT. The compositions comprise preferably 30 weight percent or less isothiazolone, more preferably 20 weight percent or less isothiazolone, more preferably 15 weight percent or less isothiazolone, preferably 12 weight percent or less isothiazolone. The compositions comprise preferably 5 weight percent or more isothiazolone, more preferably 8 weight percent or more isothiazolone.

The liquid concentrate of the present invention is substantially free of cosolvent.

The liquid concentrate of the present invention is substantially free of benzyl alcohol.

The liquid concentrate of the present invention is substantially free of triclosan.

Preferred benzoate esters are (C₄-C₂₂) alkyl benzoates, glycol benzoates, and mixtures thereof. Most preferred are glycol benzoates and their mixtures. Many of these benzoate esters are available from Eastman Chemical Company under the tradename “Benzoflex™”.

### EXAMPLES

Table 1 lists the compositions of benzoate ester plasticizers used in the examples. In each test, 12.5 g of DCOIT was added to 112.5 g of the benzoate ester plasticizer in a beaker, heated to 54° C. and held 1-2 minutes after all the DCOIT appeared to be dissolved. The compositions were mixed throughout the heating process. Each composition was transferred to a clear glass vial for 30-day solution stability testing at −10° C. and 60° C. Table 2 lists the observations after 30 days storage of the solutions.

TABLE 1

| Plasticizer | % by weight | Benzoate Ester |
|---|---|---|
| Benzoflex ™ 2088 | 50 | Diethylene glycol dibenzoate |
| | 25 | Dipropylene glycol dibenzoate |
| | 25 | Triethylene glycol dibenzoate |
| Benzoflex ™ 2-45 | 89.9 | Diethylene glycol dibenzoate |
| | 5.85 | Diethylene glycol monobenzoate |
| | 1.5 | Dipropylene glycol dibenzoate |
| Benzoflex ™ 9-8 SG | 93.0-99.8 | Dipropylene glycol dibenzoate |
| | 0.1-5.0 | Dipropylene glycol monobenzoate |
| Benzoflex ™ 131 | 98-100 | Isodecyl Benzoate |
| Benzoflex ™ 284 | 92-96 | Propylene glycol dibenzoate |
| | 1-2 | Propylene glycol monobenzoate |
| | 2-3 | Dipropylene glycol dibenzoate |
| Benzoflex ™ P-200 | 99.8-100 | Polyethylene glycol Dibenzoate |
| Benzoflex ™ 354 | 99.8-100 | 2,2,4-trimethyl-1,3-pentanediol |
| | | dibenzoate |
| Benzoflex ™ 9-88 | 89.4 | Dipropylene glycol dibenzoate |
| | 4.98 | Dipropylene glycol monobenzoate |
| | 2.35 | Propenyl Propyl Benzoate |
| | 2.29 | Propylene glycol dibenzoate |
| | 0.28 | Propylene glycol monobenzoate |

TABLE 2
Observations of 10% DCOIT in Benzoate Esters after 30 days

| | −10° C. | 60° C. |
|---|---|---|
| Benzoflex 2088 | Clear | Stable |
| Benzoflex 2-45 | Frozen, thawed clear | Stable |
| Benzoflex 9-88 SG | Clear | Stable |
| Benzoflex 131 | Clear | Stable |
| Benzoflex 284 | Clear | Stable |
| Benzoflex P-200 | Clear | Stable |
| Benzoflex-354 | Clear | Stable |
| Benzoflex 9-88 | Clear | Stable |

### Example 2

Dibenzoates from Sigma Aldrich were purchased that contain the same dibenzoates as the corresponding Benzoflex™ materials. Solutions of 10% DCOIT in the benzoate esters were prepared in Erlenmeyer flasks by adding solid DCOIT to the benzoate esters under stirring at room temperature and warming to 50° C. The resulting faint yellow solutions were transferred to snap cap flasks and stored at the given temperatures. Crystal formation in low temperature environments (cloud point) were measured according to the test method of DIN ISO 935. The solutions were also evaluated for elevated temperature stability (55° C.). Table 3 lists the stability observations for the tested solutions.

TABLE 3

| | −30° C. | 55° C. |
|---|---|---|
| Propane diol dibenzoate | Start to increased | stable |
| (replacement for Benzoflex ™ 284) | turbidity (crystal | |
| | formation) | |
| Dipropylene glycol dibenzoate | Start to increased | stable |
| (replacement for Benzoflex ™ 9-88 SG) | turbidity (crystal | |
| | formation) | |

We claim:

1. A liquid concentrate, comprising a homogeneous solution of:
a. 4 to 40 weight percent isothiazolone; and
b. 60 to 96 weight percent benzoate ester plasticizer;
wherein the concentrate is substantially free of cosolvent and triclosan.

2. The liquid concentrate of claim 1, wherein the isothiazolone is 4,5-dichloro-2-(n-octyl-4-isothiazolin-3-one) or n-octyl-4-isothiazolin-3-one.

3. The liquid concentrate of claim 1, wherein the isothiazolone is DCOIT.

4. The liquid concentrate of claim 1, comprising 30 weight percent or less isothiazolone.

5. The liquid concentrate of claim 1, comprising 15 weight percent or less isothiazolone.

6. The liquid concentrate of claim 1, comprising more than 8 weight percent isothiazolone.

7. The liquid concentrate of claim 1, wherein the benzoate ester plasticizer is a (C₄-C₂₂) alkyl benzoate, a glycol benzoate, or a mixture thereof.

8. The liquid concentrate of claim 1, wherein the benzoate ester plasticizer is a mixture of glycol benzoates.

9. The liquid concentrate of claim 1, wherein the isothiazolone is a mixture of isothiazolones.

10. The liquid concentrate of claim 1, wherein the composition is stable to crystallization or freezing at freezing or sub-freezing temperatures.
